(19) United States
(12) Patent Application Publication
(10) Pub. No.: US 2026/0219756 A1
(43) Pub. Date: Jul. 30, 2026

(54) ELECTROSTATIC-RESISTIVE TOUCH SENSOR COMPOSITION AND ELECTROSTATIC-RESISTIVE TOUCH SENSOR USING THE SAME

(71) Applicant: Korea University of Technology and Education Industry-University Cooperation Foundation, Cheonan-si (KR)

(72) Inventors: Jin Woo BAE, Seoul (KR); In Sun WOO, Cheongju-si (KR); Seung Ju OH, Cheonan-si (KR)

(73) Assignee: Korea University of Technology and Education Industry-University Cooperation Foundation, Cheonan-si (KR)

(21) Appl. No.: 19/577,732

(22) Filed: Mar. 25, 2026

Related U.S. Application Data
(63) Continuation of application No. PCT/KR2025/095648, filed on Oct. 15, 2025.

(30) Foreign Application Priority Data
Oct. 16, 2024 (KR) 10-2024-0141240

(51) Int. Cl. G06F 3/045

(52) U.S. Cl. CPC G06F 3/045; G06F 2203/04103

(57) ABSTRACT

The present invention relates to an electrostatic-resistive touch sensor composition and an electrostatic-resistive touch sensor using the same. The electrostatic-resistive touch sensor composition according to an embodiment of the present invention includes polyvinyl chloride (PVC) and butyl benzoate (BB). The weight ratio of the PVC and the BB may be 1:1.5 to 1:2.5.

### CROSS-REFERENCE TO RELATED APPLICATION

This application is a continuation application under 35 U.S.C. § 111(a) of International Patent Application No. PCT/KR2025/095648, filed Oct. 15, 2025, which claims priority to Korean Patent Application No. 10-2024-0141240, filed Oct. 16, 2024, the entire contents of each of which are incorporated herein by reference.

### BACKGROUND

The present disclosure relates to an electrostatic-resistive touch sensor composition and an electrostatic-resistive touch sensor using the same.

The present invention is the result of the project titled ‘Development of Plasticized Polymer-Based Dielectrics. Ion Conductors and Their Application to Next-Generation Organic Electronic Devices Using 3D Printing,’ conducted with the support of the National Research Foundation of Korea under the funding of the Ministry of Science and ICT in 2024 (RS-2024-00348475).

Electrostatic-resistive touch sensors use technology of detecting contact with a human finger or an object and converting the contact into an electrical signal, and play an important role in various fields such as wearable devices, portable electronic devices, human-machine interfaces, and soft robotics. These touch sensors have been developed by various methods, such as capacitive, resistive, and pressure-based methods, and each method exerts differentiated performance in terms of transparency, stretchability, sensitivity, etc.

When detecting a touch, electrostatic-resistive touch sensors determine the touch position by using changes in static electricity and resistance, and show particularly suitable properties for flexible electronic devices, or devices that require deformation. This technology is attracting attention to be used in next-generation touch sensors, with advantages of flexibility and durability as well as less power consumption.

Typical capacitive and resistive touch sensors show limitations in flexibility and transparency. Capacitive touch sensors have limited stretchability due to the fixed electrode arrangement and complex multilayer structure thereof, and this structure makes application to irregular surfaces difficult. In addition, when repeatedly deformed, typical resistive touch sensors experience performance degradation, or have low transparency, which may cause a problem with integration with displays.

Particularly, typical touch sensors require an external power supply, resulting in low energy efficiency, and also have a problem of degradation in reliability when used for a long period of time due to reduced mechanical properties of a sensor material. These problems act as factors for limiting the development of next-generation flexible electronic devices and wearable devices.

Related prior art literature includes Japanese Registered Patent Publication No. 6374610.

### SUMMARY

The present disclosure provides an electrostatic-resistive touch sensor composition having excellent position detection performance, and an electrostatic-resistive touch sensor using the same.

The present disclosure also exhibits high stretchability and transparency.

The present disclosure also has high durability.

In accordance with an exemplary embodiment of the present invention, an electrostatic-resistive touch sensor composition includes polyvinyl chloride (PVC) and butyl benzoate (BB).

The weight ratio of the PVC and the BB may be 1:1.5 to 1:2.5.

In accordance with another exemplary embodiment of the present invention, a method for manufacturing an electrostatic-resistive touch sensor layer includes dissolving polyvinyl chloride (PVC) in a solvent to prepare a PVC solution, adding butyl benzoate (BB) to the PVC solution to prepare a mixture, and removing the solvent of the mixture.

In the preparing of the mixture, the weight ratio of the PVC and the BB may be 1:1.5 to 1:2.5.

The solvent may be tetrahydrofuran (THF).

In accordance with another exemplary embodiment of the present invention, an electrostatic-resistive touch sensor includes an electrostatic-resistive touch sensor layer and an electrode disposed at an edge of the electrostatic-resistive touch sensor layer.

The electrostatic-resistive touch sensor layer may include polyvinyl chloride (PVC) and butyl benzoate (BB).

The weight ratio of the PVC and the BB may be 1:1.5 to 1:2.5.

### BRIEF DESCRIPTION OF THE DRAWINGS

Exemplary embodiments can be understood in more detail from the following description taken in conjunction with the accompanying drawings, in which:

FIG. 1 is a flowchart of a method for manufacturing an electrostatic-resistive touch sensor layer in accordance with an exemplary embodiment of the present invention;

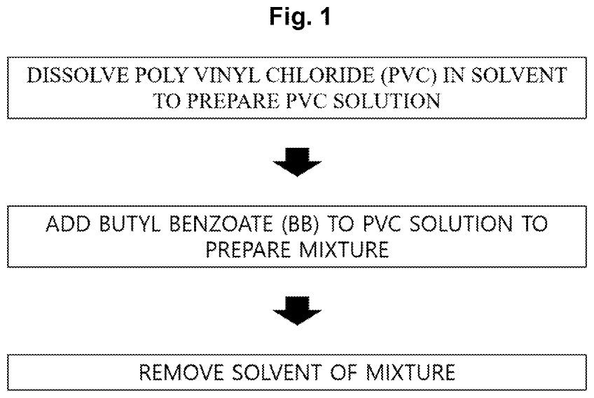

FIG. 2 is a conceptual diagram of a triboelectric nanogenerator manufactured for analysis of output voltage characteristics;

FIG. 3 shows the result of measuring the output voltage of a triboelectric nanogenerator;

FIG. 4 shows the result of measuring the power density of a triboelectric nanogenerator;

FIG. 5 shows the result of measuring the dielectric constant of an electrostatic-resistive touch sensor layer;

FIG. 6 shows the result of measuring the surface potential of an electrostatic-resistive touch sensor layer;

FIG. 7 shows a one-dimensional electrostatic-resistive touch sensor, wherein (a) shows the sensor before stretching, and (b) shows the sensor after stretching by 50%;

FIG. 8 shows a two-dimensional electrostatic-resistive touch sensor; (a) is a photograph of an actual electrostatic-resistive touch sensor, and (b) is a conceptual diagram with coordinates described for explanation;

FIG. 9 shows the result of measuring the output current according to a contact position of an electrostatic-resistive touch sensor (1D-TPS) in accordance with the present invention;

FIG. 10 shows the result of calculating the output current measured in FIG. 9 by Equation 1;

FIG. 11 shows the result of measuring the output current according to a contact position of an electrostatic-resistive touch sensor (2D-TPS) in accordance with the present invention;

FIG. 12 shows the result of calculating the output current measured in FIG. 11 by Equation 2; and

FIG. 13 shows the comparison between an actual contact position and a position calculated in FIG. 12.

The reference numerals are as follows.

100: Electrostatic-resistive touch sensor layer, 200: ITO-PET electrode, 300: Acrylic substrate, 400: Nylon, 500: Al electrode

### DETAILED DESCRIPTION OF EMBODIMENTS

Hereinafter, preferred embodiments of the present invention will be described as follows with reference to the accompanying drawings. However, embodiments of the present invention may be modified into various other forms, and the scope of the present invention is not limited to the embodiments described below. In addition, the embodiments of the present invention are provided in order to more fully describe the present disclosure to those with average knowledge in the art.

An electrostatic-resistive touch sensor composition according to an embodiment of the present invention includes polyvinyl chloride (PVC) and butyl benzoate (BB).

The polyvinyl chloride (PVC) is a synthetic plastic polymer, and is used in various industrial fields. PVC is light, has excellent durability, and is chemically stable and inexpensive. The PVC has high stretchability, and provides an elongation of 1714% or greater when mixed with a plasticizer, making it suitable for flexible and deformable electronic devices. In addition, the PVC has a high resistance, and if the PVC is added with a plasticizer, thereby serving as a dielectric, it is possible to maximize the generation of triboelectricity in an triboelectric nanogenerator. In the present invention, the PVC is combined with a plasticizer and shows optimized stretchability, transparency, and electrical properties as a touch sensor composition.

The butyl benzoate (BB) is an ester compound, and is a material formed by the combination of benzoic acid and butanol. The BB forms very flexible gel when mixed with the PVC, thereby providing an elongation of 1714% or greater. In addition, since the BB includes an alkyl group, the dielectric constant of PVC gel is increased and the triboelectric negativity is increased.

In an embodiment, the weight ratio of the PVC and the BB may be 1:1.5 to 1:2.5. When the content of BB is low, the stretchability and flexibility are decreased, and the dielectric constant is lowered, which may result in a lower power density. Conversely, when the content of BB is high, a leakage current is generated, and charges are discharged without being accumulated on the surface of the PVC gel, thereby deteriorating output performance.

In accordance with another exemplary embodiment of the present invention, a method for manufacturing an electrostatic-resistive touch sensor layer includes dissolving polyvinyl chloride (PVC) in a solvent to prepare a PVC solution, adding butyl benzoate (BB) to the PVC solution to prepare a mixture, and removing the solvent of the mixture.

In the preparing of the PVC solution, the solvent is not particularly limited as long as PVC is dissolved therein, and may preferably be tetrahydrofuran (THF). The THF may be used in an amount sufficient to dissolve the PVC. The present step may be performed by stirring at room temperature using a stirrer.

The preparing of the mixture by adding butyl benzoate (BB) to the PVC solution may be performed by adding the BB to the PVC solution in which PVC is dissolved and stirring using a stirrer. In the present step, the weight ratio of the PVC and the BB may be 1:1.5 to 1:2.5.

The removing of the solvent of the mixture may be performed by molding the mixture into a desired shape and then evaporating the solvent at a constant temperature (at room temperature in one embodiment).

An electrostatic-resistive touch sensor layer manufactured as described above has a gel form, has a transmittance of 90% or greater, has stretchability of 1700% or greater, and has an excellent dielectric constant and a high resistance of 10 MΩ or greater.

In accordance with another exemplary embodiment of the present invention, an electrostatic-resistive touch sensor includes an electrostatic-resistive touch sensor layer and an electrode disposed at an edge of the electrostatic-resistive touch sensor layer. The electrostatic-resistive touch sensor layer is manufactured by the method described above.

### Examples: Manufacturing of Electrostatic-Resistive Touch Sensor Layer

Example 1 (BB1): 2.00 g of PVC powder (Scientific Polymer Products, USA) was added to 75 ml of THF (DAEJUNG, Korea) and stirred until completely dissolved. 2.00 g of BB (Tokyo Chemical Industry, Japan) was added thereto and stirred in a stirrer at 600 rpm for 4 hours. After the stirring was completed, the mixture was poured into a petri dish and the solvent was removed by being evaporated at room temperature for 3 days. The thickness of the manufactured electrostatic-resistive touch sensor was 500 μm.

Example 2 (BB2): An electrostatic-resistive touch sensor was manufactured in the same manner as in Example 1, except that 1.26 g of PVC was added, and 2.53 g of BB was added.

Example 3 (BB3): An electrostatic-resistive touch sensor was manufactured in the same manner as in Example 1, except that 0.92 g of PVC was added, and 2.77 g of BB was added.

Example 4 (BB5): An electrostatic-resistive touch sensor was manufactured in the same manner as in Example 1, except that 0.60 g of PVC was added, and 3.01 g of BB was added.

Comparative Example 1 (DBP1): An electrostatic-resistive touch sensor was manufactured in the same manner as in Example 1, except that 2.04 g of PVC was added, and instead of BB, 2.04 g of dibutyl phthalate (DBP) was added.

Comparative Example 2 (DBP2): An electrostatic-resistive touch sensor was manufactured in the same manner as in Comparative Example 1, except that 1.30 g of PVC was added, and 2.60 g of DBP was added.

Comparative Example 3 (DBP3): An electrostatic-resistive touch sensor was manufactured in the same manner as in Comparative Example 1, except that 0.95 g of PVC was added, and 2.86 g of DBP was added.

Comparative Example 4 (DBP5): An electrostatic-resistive touch sensor was manufactured in the same manner as in Comparative Example 1, except that 0.62 g of PVC was added, and 3.11 g of DBP was added.

Comparative Example 5 (TBT1): An electrostatic-resistive touch sensor was manufactured in the same manner as in Example 1, except that 2.05 g of PVC was added, and instead of BB, 2.05 g of tributyl trimellitate (TBT) was added.

Comparative Example 6 (TBT2): An electrostatic-resistive touch sensor was manufactured in the same manner as in Comparative Example 5, except that 1.31 g of PVC was added, and 2.60 g of TBT was added.

Comparative Example 7 (TBT3): An electrostatic-resistive touch sensor was manufactured in the same manner as in Comparative Example 5, except that 0.96 g of PVC was added, and 2.88 g of TBT was added.

Comparative Example 8 (TBT5): An electrostatic-resistive touch sensor was manufactured in the same manner as in Comparative Example 5, except that 0.63 g of PVC was added, and 3.14 g of TBT was added.

### Manufacturing Example: Manufacturing of Triboelectric Nanogenerator

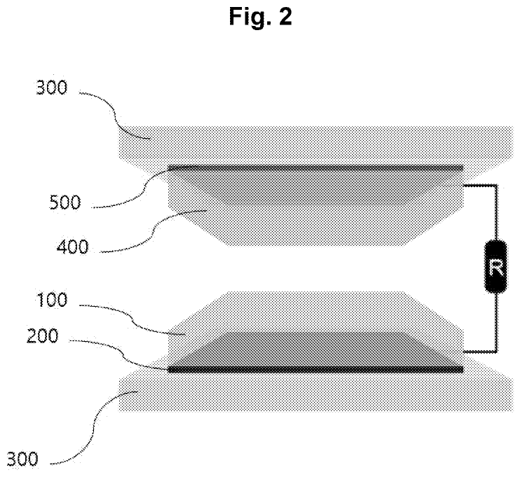

In order to analyze electrical properties, a triboelectric nanogenerator was manufactured using the electrostatic-resistive touch sensor layer of each of Examples and Comparative Examples, and a PVC film. The electrostatic-resistive touch sensor layer of each of Examples and Comparative Examples was cut to 2 cm×2 cm and an ITO-PET electrode was disposed in a lower portion thereof, and an acrylic substrate was disposed in a lower portion of the ITO-PET electrode, followed by disposing an Al electrode in an upper portion of nylon having a size of 2 cm×2 cm, and another acrylic substrate was disposed in an upper portion of the AL electrode. The electrostatic-resistive touch sensor layer and the nylon were disposed to face each other with a gap therebetween maintained at 8 mm (see FIG. 2).

The following experiments were performed using an oscilloscope (TBS2204B, Tektronix, USA), an electrometer (6514, Keithley, USA), a low-noise current amplifier (DLPCA-200, Femto, Germany), and a high-voltage probe (P5100A, Tektronix, USA).

### Experimental Example: Analysis of Output Voltage Properties

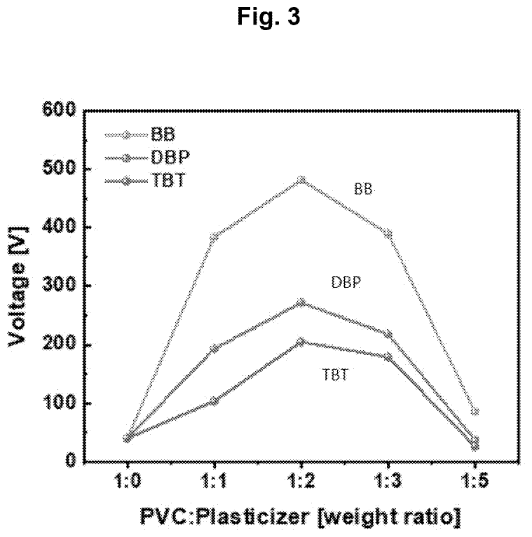

The output voltage of the triboelectric nanogenerator including the electrostatic-resistive touch sensor layer of each of Examples and Comparative Examples was measured, and the results are shown in FIG. 3.

Referring to FIG. 3, the output voltage increased until the weight ratio of PVC: plasticizer reached 1:2 in all types of plasticizers and then decreased, and Examples using BB showed an excellent output voltage compared to Comparative Examples using other plasticizers.

### Experimental Example: Analysis of Power Density Properties

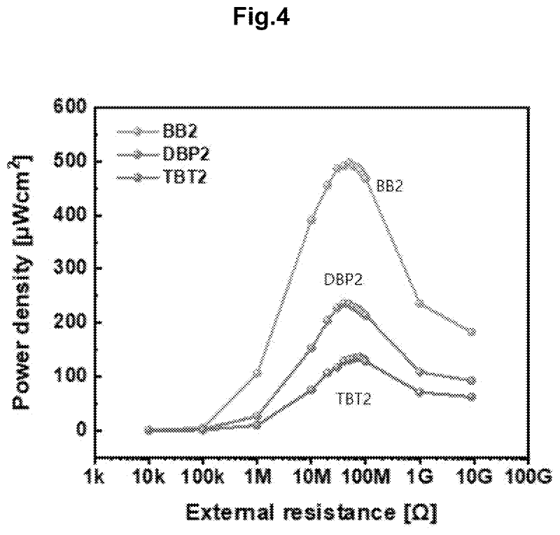

The power density of the triboelectric nanogenerator including the electrostatic-resistive touch sensor layer of each of Example 2, and Comparative Examples 2 and 6 was measured by connecting an external resistor of 10 kΩ to 10 GΩ, and the results are shown in FIG. 4.

Referring to FIG. 4, Examples using BB showed an excellent power density compared to Comparative Examples using other plasticizers.

### Experimental Example: Measurement of Dielectric Constant

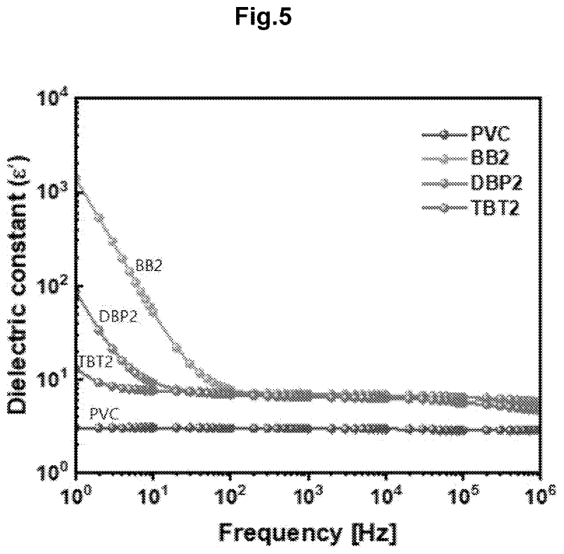

The dielectric constant of the PVC films, and the electrostatic-resistive touch sensor layers of Example 2, and Comparative Examples 2 and 6 was measured, and the results are shown in FIG. 5.

Referring to FIG. 5, when BB was used under the condition of 5 Hz, the dielectric constant was increased by 46 times compared to when the PVC films were used, and showed a very high value compared to when other plasticizers were used.

### Experimental Example: Measurement Surface Potential

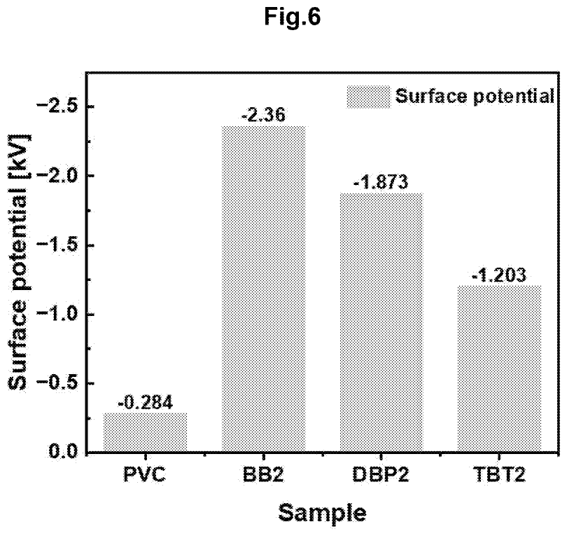

The surface potential of the PVC films, and the electrostatic-resistive touch sensor layers of Example 2, and Comparative Examples 2 and 6 was measured. The surface potential was measured for 3 hours after 100 contact-separation cycles using nylon as a triboelectric positive charge material, and the results are shown in FIG. 6.

Referring to FIG. 6, it can be seen that Example 2 using BB as a plasticizer showed the highest negative surface potential.

### Manufacturing Example: Manufacturing of Electrostatic-Resistive Touch Sensor

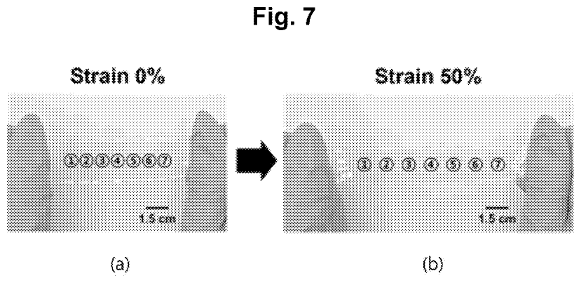

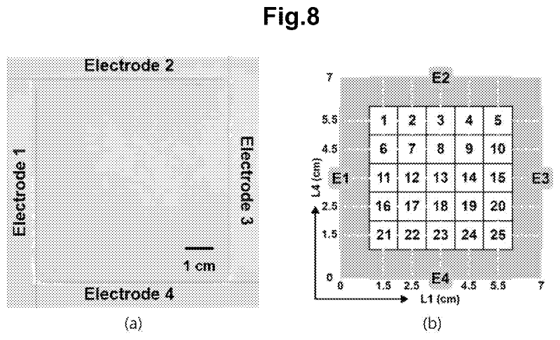

In order to analyze the performance of an electrostatic-resistive touch sensor, an electrostatic-resistive touch sensor was manufactured using the electrostatic-resistive touch sensor layer of Example 2. A one-dimensional electrostatic-resistive touch sensor (1D-TPS) was manufactured by cutting the electrostatic-resistive touch sensor layer of Example 2 to 2 cm×9 cm and attaching carbon tape to opposite sides in a far direction, and a two-dimensional electrostatic-resistive touch sensor (2D-TPS) was manufactured by cutting the electrostatic-resistive touch sensor layer of Example 2 to 7 cm×7 cm and attaching carbon tape to four sides (see FIG. 7 and FIG. 8).

### Experimental Example: Measurement of Current According to Contact Position (1D-TPS)

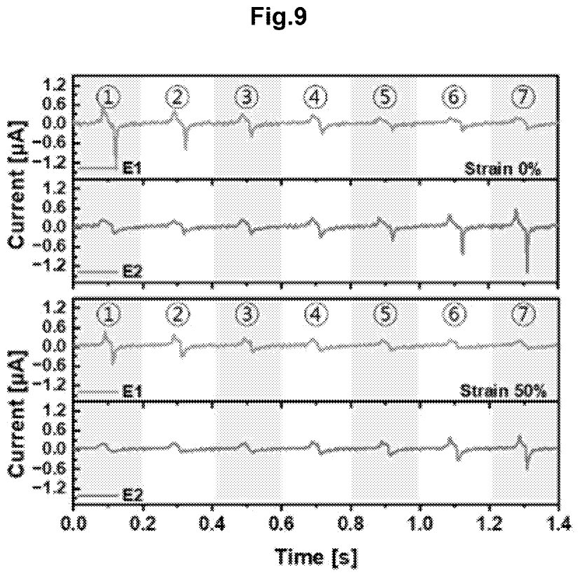

The output current was measured by sequentially pressing the position 1 to the position 7 of FIG. 7 by using the one-dimensional electrostatic-resistive touch sensor (1D-TPS) manufactured above, and the results are shown in FIG. 9. E1 is the left edge in FIGS. 7, and E2 is the right edge therein.

Referring to FIG. 9, in both cases of no stretching (FIG. 7(a)) and 50% stretching (FIG. 7(b)), the contact position and the output current showed an inversely proportional relationship, so that it can be seen that the electrostatic-resistive touch sensor of the present invention has excellent stretchability, stability, and sensitivity.

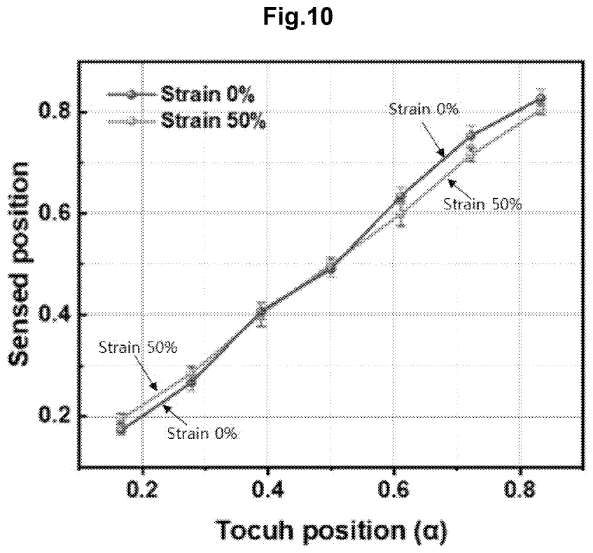

FIG. 10 shows the result of calculating the output current measured in FIG. 9 by Equation 1 below.

$$\text{?}$$

$$\text{?} \text{indicates text missing or illegible when filed}$$

(I₁ and I₂ are measured current values, L₁ and L₂ are each the length from a contact position to each electrode, and R₁ and R₂ are resistances.)

Referring to FIG. 10, it can be seen that both before and after the stretching, the slope of an actual contact position with respect to a calculated position was 0.95 or greater, showing a very low error when compared to an ideal slope of 1.

### Experimental Example: Measurement of Current According to Contact Position (2D-TPS)

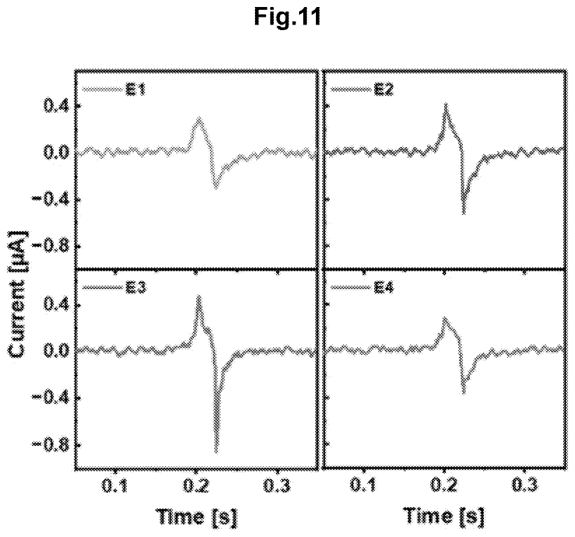

The output current was measured after contacting the crossing points 9, 10, 14, and 15 of FIG. 8(b) by using the two-dimensional electrostatic-resistive touch sensor (2D-TPS) manufactured above, and the results are shown in FIG. 11.

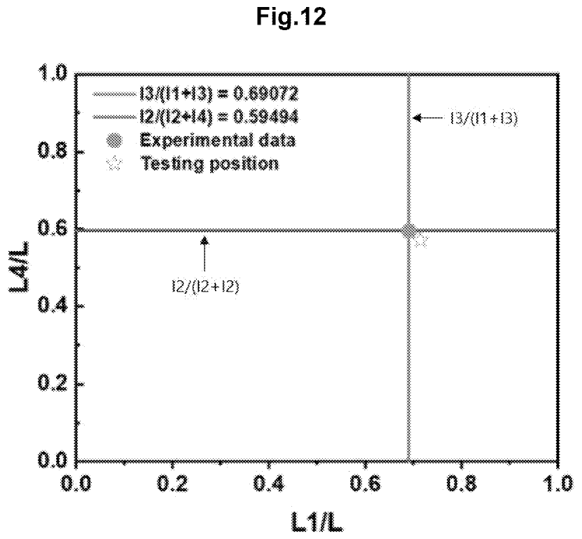

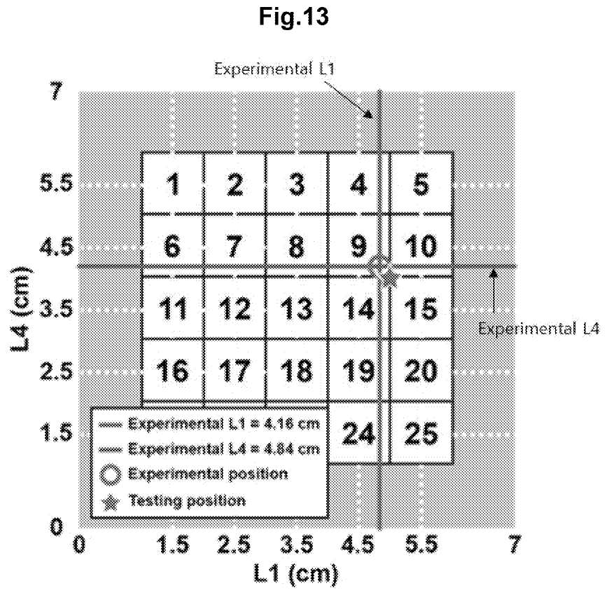

In addition, the result of calculating the output current measured in FIG. 11 by Equation 2 below is shown in FIG. 12, and the comparison between an actual contact position and the result of the calculation by Equation 2 is shown in FIG. 13.

$$\text{?}$$

$$\text{?} \text{indicates text missing or illegible when filed}$$

(I₁ to I₄ are measured current values, L₁ to L₄ are each the length from a contact position to each electrode, and R₁ to R₄ are resistances.)

Referring to FIG. 13, since an actual contact position is very close to a calculated position, it can be seen that measurement accuracy is also excellent in two dimensions.

An electrostatic-resistive touch sensor composition according to an embodiment of the present invention and an electrostatic-resistive touch sensor using the same have excellent position detection performance.

The present invention also exhibits high stretchability and transparency.

The present invention also has high durability.

The present invention is not limited by the above-described embodiments and the accompanying drawings, but is intended to be limited by the appended claims. Accordingly, various types of substitutions, modifications, and changes may be made by those skilled in the art within the scope not departing from the technical spirit of the present disclosure described in the claims, and these substitutions, modifications, and changes may also belong to the scope of the present disclosure.

What is claimed is:

1. An electrostatic-resistive touch sensor composition comprising:
polyvinyl chloride (PVC); and
butyl benzoate (BB).

2. The electrostatic-resistive touch sensor composition of claim 1, wherein the weight ratio of the PVC and the BB is 1:1.5 to 1:2.5.

3. A method for manufacturing an electrostatic-resistive touch sensor layer, the method comprising:
dissolving polyvinyl chloride (PVC) in a solvent to prepare a PVC solution;
adding butyl benzoate (BB) to the PVC solution to prepare a mixture; and
removing the solvent of the mixture.

4. The method of claim 3, wherein in the preparing of the mixture, the weight ratio of the PVC and the BB is 1:1.5 to 1:2.5.

5. The method of claim 3, wherein the solvent is tetrahydrofuran (THF).

6. An electrostatic-resistive touch sensor comprising:
an electrostatic-resistive touch sensor layer; and
an electrode disposed at an edge of the electrostatic-resistive touch sensor layer,
wherein the electrostatic-resistive touch sensor layer includes polyvinyl chloride (PVC) and butyl benzoate (BB).

7. The electrostatic-resistive touch sensor of claim 6, wherein the weight ratio of the PVC and the BB is 1:1.5 to 1:2.5.
